(19) United States
(12) Patent Application Publication
(10) Pub. No.: US 2013/0289954 A1
(43) Pub. Date: Oct. 31, 2013

(54) COMPUTING DEVICE AND METHOD FOR SIMULATING MEASUREMENT PATH OF PROBE OF MEASUREMENT MACHINE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); WEI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/859,540

(22) Filed: Apr. 9, 2013

(30) Foreign Application Priority Data
Apr. 27, 2012 (CN) 201210127583.5

(51) Int. Cl. G06F 17/50

(52) U.S. Cl. CPC G06F 17/5009
USPC 703/2

(57) ABSTRACT

In a method for simulating a measurement path of a probe using a computing device, a standard ball is constructed by meshing shell surface points. Measurement points from the surface of the standard ball are selected, and a coordinate value of each of the measurement points is calculated. The method calculates a coordinate value of each moving point of the probe, and inserts the coordinate value of each moving point between the two adjacent measurement points into the data array. The method simulates probe movement path of the probe according to coordinate values stored in the data array, and detects any collision between the probe and the standard ball at each point of the probe movement path. A probe calibration program is generated according to the probe movement path when no collisions with the standard ball is found.

### BACKGROUND

1. Technical Field

Embodiments of the present disclosure relate to three-dimensional (3D) measurement systems and methods, and particularly to simulation of a measurement path of a probe of a measurement machine.

2. Description of Related Art

Coordinate measurement machines, such as image measuring machines, can be used to perform a variety of measurement and coordinate acquisition tasks. In a coordinate measurement machine, a movable arm can be connected to a probe for measuring various dimensions of workpieces. To obtain precision and accuracy of the measurements, the probe must be calibrated before it can be used in the measurement machine. The probe calibration process is performed along a precision measurement path of the probe to obtain acceptable calibration results. However, this is not the same as constructing the measurement path of the probe, which is time-consuming as the probe needs to be manually manipulated between various measuring positions of the workpiece if the moving path of the probe is not precise.

### BRIEF DESCRIPTION OF THE DRAWINGS

FIG. 1 is a block diagram of one embodiment of a computing device including a probe measurement path simulating system.

FIG. 2 is a flowchart of one embodiment of a method for simulating a measurement path of a probe using the computing device of FIG. 1.

FIG. 3 is a detailed flowchart of step S22 of FIG. 2.

FIG. 4 shows schematic diagrams illustrating one exemplary of meshing a surface shell of a standard ball in a UV plane.

FIG. 5 is a schematic diagram illustrating a part of the moving points of the probe when the probe moves along the surface of the standard ball.

FIG. 6 is a schematic diagram illustrating a plurality of movement paths of the probe when the probe moves along the surface of the standard ball.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

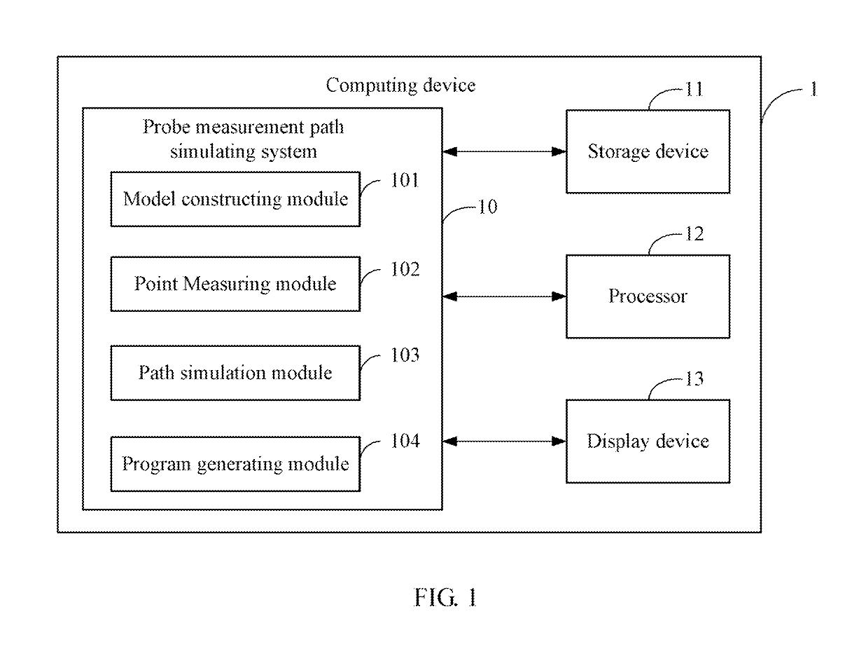

FIG. 1 is a block diagram of one embodiment of a computing device 1 including a probe measurement path simulating system 10. In the embodiment, the computing device 1 further includes a storage device 11, a processor 12, and a display device 13. The probe measurement path simulating system 10 may include a plurality of functional modules that are stored in the storage device 11 and executed by the processor 12. The computing device 1 may be a computer, a server, or a measurement machine. FIG. 1 is only one example of the computing device 1, other examples may include more or fewer components than those shown in the embodiment, or have a different configuration of the various components.

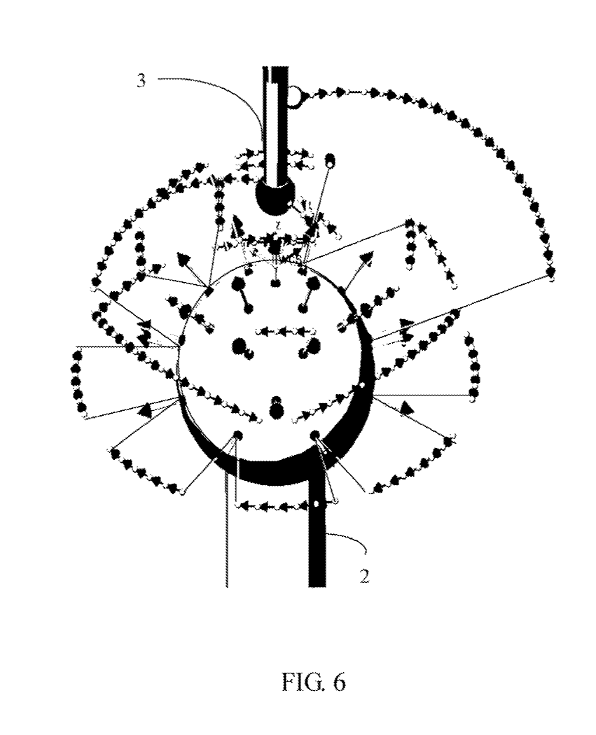

The storage device 11 stores a ball graphics file of a standard ball 2 (shown in FIG. 6), and a probe graphics file of a probe 3 (also shown in FIG. 6). The ball model file contains shell data of the standard ball 2 for describing a geometrical shell of the standard ball 2. The probe graphics file contains shell data of the probe 3 for describing a geometrical shell of the probe 3. In one embodiment, the storage device 11 may be an internal storage device, such as a random access memory (RAM) for temporary storage of information, and/or a read only memory (ROM) for permanent storage of information. The storage device 11 may also be an external storage device, such as an external hard disk, a storage card, or a data storage medium.

In one embodiment, the probe measurement path simulating system 10 includes a model constructing module 101, a point measuring module 102, a path simulation module 103, and a program generating module 104. The modules 101-104 may comprise computerized instructions in the form of one or more programs that are stored in the storage device 11 and executed by the at least one processor 12. A detailed description of each module will be given in the following paragraphs.

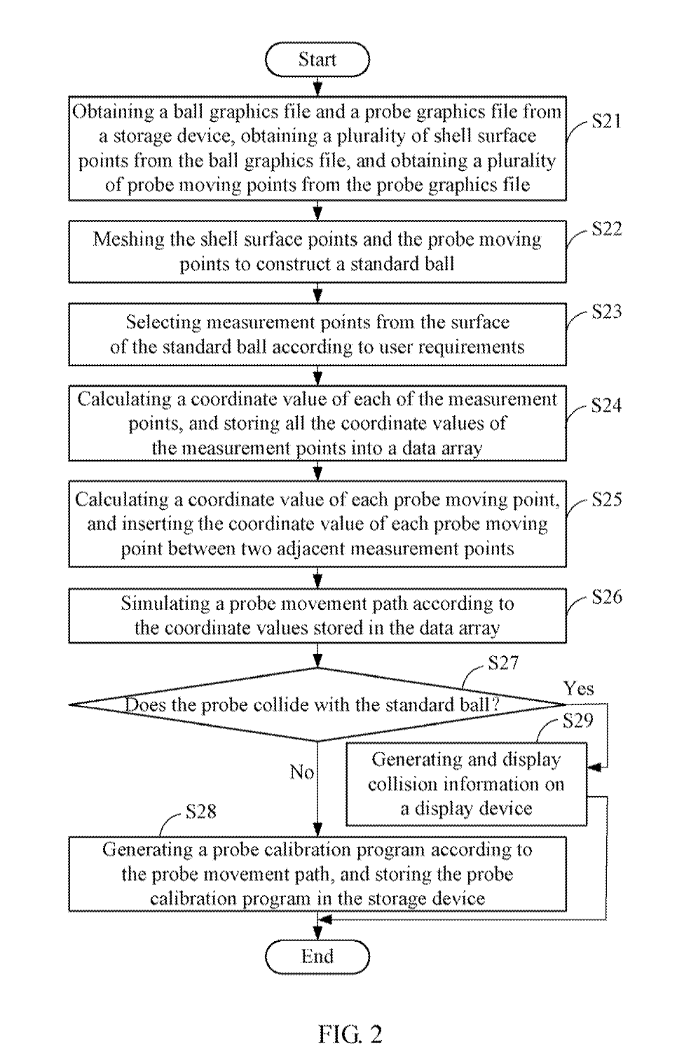

FIG. 2 is a flowchart of one embodiment of a method for simulating a measurement path of the probe 3 using the computing device 1 of FIG. 1. Depending on the embodiment, additional steps may be added, others removed, and the ordering of the steps may be changed.

In step S21, the model constructing module 101 obtains a ball graphics file of the standard ball 2 and a probe graphics file of the probe 3 from the storage device 11, obtains a plurality of shell surface points of the standard ball 2 from the ball graphics file, and obtains a plurality of moving points of the probe 3 from the probe graphics file.

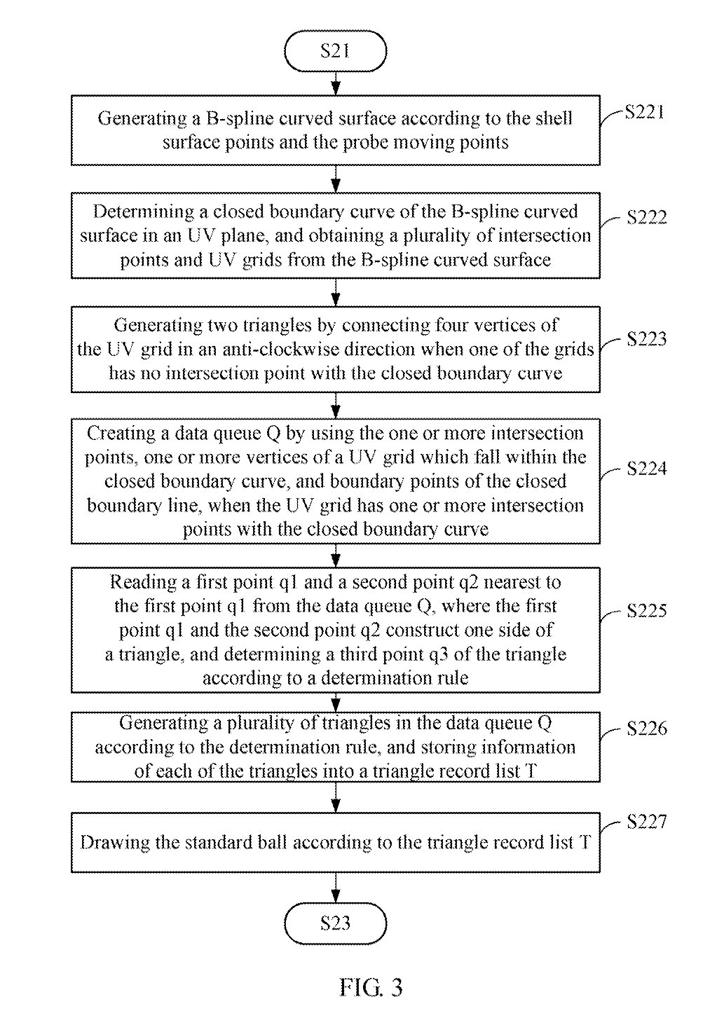

In step S22, the model constructing module 101 meshes the shell surface points and the moving points of the probe 3 to construct the standard ball 2 using a curve meshing method. In one embodiment, the curve meshing method is a point fitting process of constructing a geometrical curve using different mesh grids of measurement points of the standard ball 2 (shown in FIG. 6). The detailed description of step S22 is described in FIG. 3.

In step S23, the point measuring module 102 selects a plurality of measurement points from the surface of the standard ball 2 according to user requirements. In the embodiment, N number of measurement points (i.e., Pt1, Pt2, Pt3, . . . Ptn) are selected from the surface of the standard ball 2.

In step S24, the point measuring module 102 calculates a coordinate value of each of the measurement points, and stores all the coordinate values of the measurement points into a data array. In the embodiment, the standard ball 2 is divided into a plurality of surface shells, such as five surface shells, for example. The adjacent angle between two surface shells may be 90 degrees, thus A=90 degrees. The point measuring module 102 calculates a coordinate value of a center point p of the standard ball 2 according to a first measurement point pt1 and a radius R of the standard ball 2, and calculates a center point p1 of each of the surface shells according to the adjacent angle between two surface shells and the center point p of the standard ball 2. The center point p of the standard ball 2 is denoted as p(x1, y1, z1). The center point p1 (p1.x, p1.y, p1.z) of each of the surface shells is calculated according to the following formulas: p1.x=x1+nor.x*sin A*R, p1.y=y1+nor.x*sin A*R, and p1.z=z1+nor.x*sin A*R, where “nor” represents a normal vector of the probe 3 that is defined as a value of nor (0, 0, 1).

The point measuring module 102 calculates the coordinate value of each of the measurement points by performing the following steps:

(a). constructing a first circle according to the value of nor (0, 0, 1) and the center point p1 of each of the surface shells, and selecting a second measurement point pt2 (x2, y2, z2) from the first circle, where x2=p1.x+r, y2=p1.y and z2=p1.z, and r represents a radius of the first circle r=R*cos A.;
(b) rotating the first measurement point pt1 to point to the normal vector of the probe 3, and constructing a second circle according to the radius of the first circle and the center point p1 of each of the surface shells, and selecting a third measurement point pt3 (x3, y3, z3) from the second circle;
(c) determining a secure angle A1 for assuring that the probe 3 does not collide with the standard ball 2, and constructing a data matrix according to the secure angle A1 and the center point p1 of each of the surface shells; and
(d) performing a multiplication of values of the data matrix and the coordinate value of the third measurement point pt3 to obtain the Nth number measurement point Ptn.

In step S25, the point measuring module 102 calculates a coordinate value of each of the moving points of the probe 3 according to two adjacent measurement points and the normal vector of the probe 3, and inserts the coordinate value of each of the moving points of the probe 3 between the two adjacent measurement points into the data array.

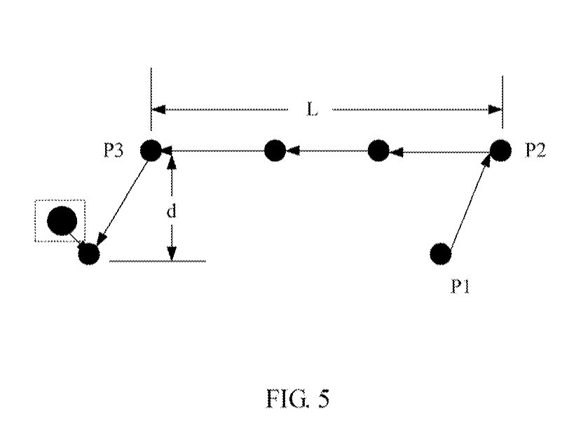

FIG. 5 is a schematic diagram illustrating a part of the moving points of the probe 3 when the probe 3 moves along the surface of the standard ball 2. In the embodiment, the point measuring module 102 calculates the coordinate value of each of the moving points of the probe by performing the following steps:

(a). selecting an initial point from the surface shell of the standard ball as a first moving point P1 of the probe 3, and obtaining a second moving point P2 of the probe 3 according to the coordinate value of the first moving point P1 and the normal vector of the probe 3;
(b). drawing an arc based on the first moving point P1 and the second moving point P2, and calculating a length of the arc L=R*A1, where R represents the radius of the standard ball 2 and A1 represents a centre angle of the arc;
(c) constructing a point matrix M according to the length L of the arc and the normal vector of the probe 3, i.e. multiplying each value of nor (0, 0, 1) by the length L of the arc to obtain the point matrix M; and
(d) performing a multiplication of values of the point matrix M and the coordinate value of the second moving point P2 to obtain the coordinate value of the Nth number moving point Pn.

In step S26, the path simulation module 103 draws a probe movement path (shown in FIG. 6) according to the coordinate values stored in the data array, and detects any collision between the probe 3 and the standard ball 2 at each point of the probe movement path. In one embodiment, the collision detection is by performed by determining whether the distance between the center point of the probe 3 and the center point of the standard ball 2 is less than an addition value of the radius of the standard ball 2 and the radius of the probe 3.

In step S27, the path simulation module 103 determines whether the probe 3 collides with the standard ball 2 according to the collision detection. If the probe 3 does not collide with the standard ball 2, step S28 is implemented. If the probe 3 does collide with the standard ball 2, step S29 is implemented.

In step S28, the program generating module 104 generates a probe calibration program according to the probe movement path, and stores the probe calibration program in the storage device 11. In the embodiment, the probe calibration program may be an I++ measurement program that is used to calibrate a measurement path of the probe 3. One example of the I++ measurement program is generated by performing the following steps: obtaining the coordinate value of each point in the data array such as PtMeas (C0001, . . . , C0025), and if the coordinate value of a point is not (0, 0, 0), the program generating module 104 replaces the coordinate value of the point with PtMeas (x, y, z) to generate the I++ measurement program. If the coordinate value of the point is (0, 0, 0), the program generating module 104 replaces IJK(0, 0, 0)with PtMeas (x, y, z) to generate the I++ measurement program.

In step S29, the program generating module 104 generates any collision information indicating that the probe 3 is colliding with the standard ball 2, and displays the collision information on the display device 13.

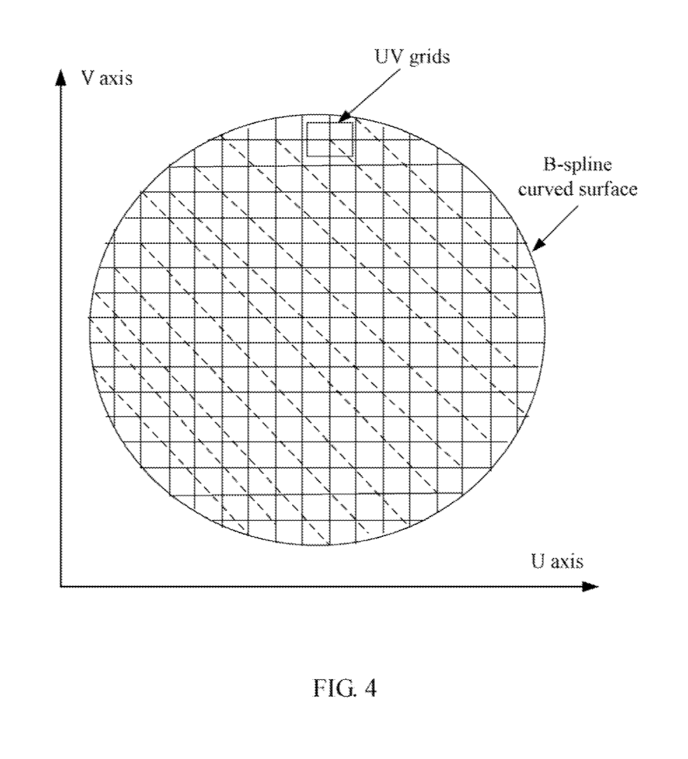

FIG. 3 is a detailed flowchart of step S22 in FIG. 2. In step S221, the model constructing module 101 generates a B-spline curved surface of the standard ball 2 according to the shell surface points of the standard ball 2 and the moving points of the probe 3. One example of the B-spline curved surface of the standard ball 2 is shown in FIG. 4.

In step S222, the model constructing module 101 determines a closed boundary curve of the B-spline curved surface in a UV plane, and obtains a plurality of intersection points and UV grids from the B-spline curved surface. The model constructing module 101 further divides the closed boundary curve to obtain a plurality of UV grids (shown in FIG. 4) using a plurality of horizontal lines (hereinafter referred to as “U-lines”) and vertical lines (hereinafter referred to as “V-lines”).

In step S223, the model constructing module 101 generates two triangles by connecting four vertices of the UV grid in an anti-clockwise direction when one of the UV grids has no intersection point with the closed boundary curve. Referring to FIG. 4, the B-spline curved surface of the standard ball contains a plurality of UV grids in the UV plane, and each of the UV grids has four vertices.

In step S224, the model constructing module 101 creates a data queue Q by using the one or more intersection points, one or more vertices of a UV grid which fall within the closed boundary curve, and boundary points of the closed boundary line, when the UV grid has one or more intersection points with the closed boundary curve.

In step S225, the model constructing module 101 reads a first point q1 and a second point q2 nearest to the first point q1 from the data queue Q, where the first point q1 and the second point q2 construct one side of a triangle, and determines a third point q3 of the triangle according to a determination rule that there is no point of the data queue Q in a circumcircle of the triangle which consists of the first point, the second point and the third point.

In step S226, the model constructing module 101 generates a plurality of triangles in the data queue Q according to the determination rule, and stores information of each of the triangles into a triangle record list T.

In step S227, the model constructing module 101 draws a model of the standard ball 2 according to the triangle record list T, and displays the model of the standard ball 2 on the display device 13.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage device and at least one processor; and
one or more programs stored in the storage device and executed by the at least one processor, the one or more programs comprising:
a model constructing module that obtains a ball graphics file of a standard ball and a probe graphics file of a probe from the storage device, obtains a plurality of shell surface points of the standard ball from the ball graphics file, obtains a plurality of moving points of the probe from the ball graphics file, and meshes the shell surface points and the moving points of the probe to construct the standard ball;
a point measuring module that selects a plurality of measurement points from the surface of the standard ball according to user requirements, calculates a coordinate value of each of the measurement points, stores all the coordinate values of the measurement points into a data array, calculates a coordinate value of each of the moving points of the probe according to two adjacent measurement points and the normal vector of the probe, and inserts the coordinate value of each of the moving points of the probe between the two adjacent measurement points into the data array;
a path simulation module that draws a probe movement path of the probe according to the coordinate values stored in the data array, detects a collision between the probe and the standard ball at each point of the probe movement path, and determines whether the probe collides with the standard ball according to the collision detection; and
a program generating module that generates a probe calibration program according to the probe movement path when the probe does not collide with the standard ball, and stores the probe calibration program in the storage device.

2. The computing device according to claim 1, wherein the program generating module further generates collision information indicating that the probe is colliding with the standard ball, and displays the collision information on a display device of the computing device.

3. The computing device according to claim 1, wherein the standard ball is constructed by steps of:
generating a B-spline curved surface of the standard ball according to the shell surface points of the standard ball and the moving points of the probe;
determining a closed boundary curve of the B-spline curved surface in a UV plane, and obtains a plurality of intersection points and UV grids from the B-spline curved surface;
generating two triangles by connecting four vertices of the UV grid in an anti-clockwise direction when one of the UV grids has no intersection point with the closed boundary curve;
creating a data queue by using the one or more intersection points, one or more vertices of a UV grid which fall within the closed boundary curve, and boundary points of the closed boundary line, when the UV grid has one or more intersection points with the closed boundary curve;
reading a first point and a second point nearest to the first point from the data queue, where the first point and the second point construct one side of a triangle, and determines a third point q3 of the triangle according to a determination rule;
generating a plurality of triangles in the data queue according to the determination rule, and stores information of each of the triangles into a triangle record list; and
drawing a model of the standard ball according to the triangle record list.

4. The computing device according to claim 3, wherein the determination rule is defined a rule that there is no point of the data queue in a circumcircle of the triangle which is consisting of the first point, the second point and the third point.

5. The computing device according to claim 1, wherein the coordinate value of each of the measurement points is calculated by steps of:
dividing the standard ball into a plurality of surface shells, and defining an adjacent angle between two surface shells;
selecting a first measurement point from a top surface shell of the standard ball;
calculating a coordinate value of a center point of the standard ball according to the first measurement point and a radius of the standard ball;
calculating a center point of each of the surface shells according to the adjacent angle between the two surface shells and the center point of the standard ball;
constructing a first circle according to a normal vector of the probe and the center point of each of the surface shells, and selecting a second measurement point from the first circle;
rotating the first measurement point to point to the normal vector of the probe, and constructing a second circle according to the radius of the first circle and the center point of each of the surface shells, and selecting a third measurement point from the second circle;
determining a secure angle for assuring that the probe does not collide with the standard ball, and constructing a data matrix according to the secure angle and the center point of each of the surface shells; and
performing a multiplication of each value of the data matrix and the coordinate value of the third measurement point to obtain the Nth number measurement point.

6. The computing device according to claim 1, wherein the coordinate value of each of the moving points of the probe is calculated by steps of:
selecting an initial moving point from the surface of the standard ball as a first moving point of the probe, and obtaining a second moving point of the probe according to the coordinate value of the first moving point and a normal vector of the probe;
drawing an arc based on the first moving point and the second moving point, and calculating a length of the arc;
constructing a point matrix according to the length of the arc and the normal vector of the probe; and
performing a multiplication of each values of the point matrix and the coordinate value of the second moving point to obtain the coordinate value of the Nth number moving point of the probe.

7. A method for simulating a measurement path of a probe using a computing device, the method comprising steps of:
obtaining a ball graphics file of a standard ball and a probe graphics file of the probe from a storage device of the computing device, obtaining a plurality of shell surface points of the standard ball from the ball graphics file, and obtaining a plurality of moving points of the probe from the probe graphics file;
meshing the shell surface points and the moving points of the probe to construct the standard ball;
selecting a plurality of measurement points from the surface of the standard ball according to user requirements, calculating a coordinate value of each of the measurement points, and storing all the coordinate values of the measurement points into a data array;
calculating a coordinate value of each of the moving points of the probe according to two adjacent measurement points and the normal vector of the probe, and inserting the coordinate value of each of the moving points of the probe between the two adjacent measurement points into the data array;
drawing a probe movement path of the probe according to the coordinate values stored in the data array, and detecting a collision between the probe and the standard ball at each point of the probe movement path;
determining whether the probe collides with the standard ball according to the collision detection; and
generating a probe calibration program according to the probe movement path when the probe does not collide with the standard ball, and storing the probe calibration program in the storage device.

8. The method according to claim 7, further comprising:
generating collision information indicating that the probe is colliding with the standard ball, and displaying the collision information on a display device of the computing device.

9. The method according to claim 7, wherein the standard ball is constructed by steps of:
generating a B-spline curved surface of the standard ball according to the shell surface points of the standard ball and the moving points of the probe;
determining a closed boundary curve of the B-spline curved surface in a UV plane, and obtains a plurality of intersection points and UV grids from the B-spline curved surface;
generating two triangles by connecting four vertices of the UV grid in an anti-clockwise direction when one of the UV grids has no intersection point with the closed boundary curve;
creating a data queue by using the one or more intersection points, one or more vertices of a UV grid which fall within the closed boundary curve, and boundary points of the closed boundary line, when the UV grid has one or more intersection points with the closed boundary curve;
reading a first point and a second point nearest to the first point from the data queue, where the first point and the second point construct one side of a triangle, and determines a third point q3 of the triangle according to a determination rule;
generating a plurality of triangles in the data queue according to the determination rule, and stores information of each of the triangles into a triangle record list; and
drawing a model of the standard ball according to the triangle record list.

10. The method according to claim 9, wherein the determination rule is defined a rule that there is no point of the data queue in a circumcircle of the triangle which is consisting of the first point, the second point and the third point.

11. The method according to claim 7, wherein the coordinate value of each of the measurement points is calculated by steps of:
dividing the standard ball into a plurality of surface shells, and defining an adjacent angle between two surface shells;
selecting a first measurement point from a top surface shell of the standard ball;
calculating a coordinate value of a center point of the standard ball according to the first measurement point and a radius of the standard ball;
calculating a center point of each of the surface shells according to the adjacent angle between the two surface shells and the center point of the standard ball;
constructing a first circle according to a normal vector of the probe and the center point of each of the surface shells, and selecting a second measurement point from the first circle;
rotating the first measurement point to point to the normal vector of the probe, and constructing a second circle according to the radius of the first circle and the center point of each of the surface shells, and selecting a third measurement point from the second circle;
determining a secure angle for assuring that the probe does not collide with the standard ball, and constructing a data matrix according to the secure angle and the center point of each of the surface shells; and
performing a multiplication of each value of the data matrix and the coordinate value of the third measurement point to obtain the Nth number measurement point.

12. The method according to claim 7, wherein the coordinate value of each of the moving points of the probe is calculated by steps of:
selecting an initial moving point from the surface of the standard ball as a first moving point of the probe, and obtaining a second moving point of the probe according to the coordinate value of the first moving point and a normal vector of the probe;
drawing an arc based on the first moving point and the second moving point, and calculating a length of the arc;
constructing a point matrix according to the length of the arc and the normal vector of the probe; and
performing a multiplication of each values of the point matrix and the coordinate value of the second moving point to obtain the coordinate value of the Nth number moving point of the probe.

13. A non-transitory computer-readable storage medium having stored thereon instructions that, when executed by at least one processor of a computing device, causes the computing device to perform a method for simulating a measurement path of a probe, the method comprising steps of:
obtaining a ball graphics file of a standard ball and a probe graphics file of the probe from a storage device of the computing device, obtaining a plurality of shell surface points of the standard ball from the ball graphics file, and obtaining a plurality of moving points of the probe from the probe graphics file;
meshing the shell surface points and the moving points of the probe to construct the standard ball;
selecting a plurality of measurement points from the surface of the standard ball according to user requirements, calculating a coordinate value of each of the measurement points, and storing all the coordinate values of the measurement points into a data array;
calculating a coordinate value of each of the moving points of the probe according to two adjacent measurement points and the normal vector of the probe, and inserting the coordinate value of each of the moving points of the probe between the two adjacent measurement points into the data array;
drawing a probe movement path of the probe according to the coordinate values stored in the data array, and detecting a collision between the probe and the standard ball at each point of the probe movement path;
determining whether the probe collides with the standard ball according to the collision detection; and
generating a probe calibration program according to the probe movement path when the probe does not collide with the standard ball, and storing the probe calibration program in the storage device.

14. The storage medium according to claim 13, wherein the method further comprises:
generating collision information indicating that the probe is colliding with the standard ball, and displaying the collision information on a display device of the computing device.

15. The storage medium according to claim 13, wherein the standard ball is constructed by steps of:
generating a B-spline curved surface of the standard ball according to the shell surface points of the standard ball and the moving points of the probe;
determining a closed boundary curve of the B-spline curved surface in a UV plane, and obtains a plurality of intersection points and UV grids from the B-spline curved surface;
generating two triangles by connecting four vertices of the UV grid in an anti-clockwise direction when one of the UV grids has no intersection point with the closed boundary curve;
creating a data queue by using the one or more intersection points, one or more vertices of a UV grid which fall within the closed boundary curve, and boundary points of the closed boundary line, when the UV grid has one or more intersection points with the closed boundary curve;
reading a first point and a second point nearest to the first point from the data queue, where the first point and the second point construct one side of a triangle, and determines a third point q3 of the triangle according to a determination rule;
generating a plurality of triangles in the data queue according to the determination rule, and stores information of each of the triangles into a triangle record list; and
drawing a model of the standard ball according to the triangle record list.

16. The storage medium according to claim 15, wherein the determination rule is defined a rule that there is no point of the data queue in a circumcircle of the triangle which is consisting of the first point, the second point and the third point.

17. The storage medium according to claim 13, wherein the coordinate value of each of the measurement points is calculated by steps of:
dividing the standard ball into a plurality of surface shells, and defining an adjacent angle between two surface shells;
selecting a first measurement point from a top surface shell of the standard ball;
calculating a coordinate value of a center point of the standard ball according to the first measurement point and a radius of the standard ball;
calculating a center point of each of the surface shells according to the adjacent angle between the two surface shells and the center point of the standard ball;
constructing a first circle according to a normal vector of the probe and the center point of each of the surface shells, and selecting a second measurement point from the first circle;
rotating the first measurement point to point to the normal vector of the probe, and constructing a second circle according to the radius of the first circle and the center point of each of the surface shells, and selecting a third measurement point from the second circle;
determining a secure angle for assuring that the probe does not collide with the standard ball, and constructing a data matrix according to the secure angle and the center point of each of the surface shells; and
performing a multiplication of each value of the data matrix and the coordinate value of the third measurement point to obtain the Nth number measurement point.

18. The storage medium according to claim 13, wherein the coordinate value of each of the moving points of the probe is calculated by steps of:
selecting an initial moving point from the surface of the standard ball as a first moving point of the probe, and obtaining a second moving point of the probe according to the coordinate value of the first moving point and a normal vector of the probe;
drawing an arc based on the first moving point and the second moving point, and calculating a length of the arc;
constructing a point matrix according to the length of the arc and the normal vector of the probe; and
performing a multiplication of each values of the point matrix and the coordinate value of the second moving point to obtain the coordinate value of the Nth number moving point of the probe.
